(19) United States
(12) Patent Application Publication
(10) Pub. No.: US 2005/0130594 A1
(43) Pub. Date: Jun. 16, 2005

(54) Walkie-talkie pen

(76) Inventors: Charles J. Kowalski, Ridgewood, NJ (US); Jeffrey H. Rosen, Aventura, FL (US); Lawrence I. Rosen, Mendham, NJ (US)

Correspondence Address: Ralph W. Selitto, Jr.;McCarter & English, LLP, Four Gateway Center, 100 Mulberry Street, Newark, NJ, 07102, US

(21) Appl. No.: 10/964,859

(22) Filed: Oct. 14, 2004

Related U.S. Application Data
(60) Provisional application No. 60/530,209, filed on Dec. 16, 2003.

(51) Int. Cl. H04B 7/00; H04M 1/00

(52) U.S. Cl. 455/66.1; 455/556.1

(57) ABSTRACT

A combination pen and walkie-talkie device includes a walkie-talkie incorporated within the housing of a writing pen such that the walkie-talkie function of the device is well concealed. The antenna of the walkie-talkie is concealed by being entirely enclosed within the pen housing. Examples include a combination pen and walkie-talkie device in which the walkie-talkie circuitry operates at a transmit/receive frequency within a range of from about 462 MHz to about 467 MHz, and/or in which the transmit/receive antenna is a half-wavelength antenna having a free length greater than one foot.

### CROSS-REFERENCE TO EXISTING APPLICATION

This application claims the priority of U.S. Provisional Patent Application Ser. No. 60/530,209, filed Dec. 16, 2003, the disclosure of which application is hereby incorporated herein in its entirety.

### FIELD OF THE INVENTION

The present invention relates to communications devices, particularly miniature two-way radios.

### BACKGROUND OF THE INVENTION

Two-way radios (i.e., radios capable of alternately transmitting and receiving communications signals on the same frequency) have been known in the art for a number of years. Such radios, commonly referred to as “walkie-talkies”, have traditionally been equipped with a relatively large housing so as to contain the electronic components necessary to generate the desired frequency, and an antenna mounted to the housing and protruding therefrom. Typically, walkie-talkie devices on the market have operated at the 27 MHz or 49 MHz frequencies.

The length of a walkie-talkie's antenna is a function of its transmitting frequency. In particular, according to the formula Lₐ=984/F, a full-wavelength antenna for a walkie-talkie operating at a transmit frequency F of 27 MHz would be required to have a length Lₐ of 36 feet. For this reason, walkie-talkies operating at this frequency and other similar frequencies are often equipped with relatively shorter ⅛ wavelength antennas mounted to their housings. While still relatively long, such antennas can improve the portability and practicality of the walkie-talkie units in which they are incorporated.

Advances in electronics have enabled the development of progressively smaller walkie-talkie devices that may be installed in the housings of common personal items. Unfortunately, however, due to the above-described minimum length requirements, the antennas of such devices are still somewhat long. To the extent such devices have been made of compact size for the purpose of concealing their communications function within the housing of a personal item, the high visibility of long antennas mounted to the respective personal item housings is a clear drawback. Novel apparatus and methods for equipping common personal items with well-concealed walkie-talkie functionality are therefore both necessary and desirable.

### SUMMARY OF THE INVENTION

The present invention provides a walkie-talkie incorporated within the housing of a writing pen such that the walkie-talkie function of the device is well concealed and the appearance of the device is substantially similar to that of many conventional ball-point pen writing devices. More particularly, the antenna of the walkie-talkie to which the walkie-talkie circuitry is coupled for transmission and reception of communications signals is concealed by being entirely enclosed within the pen housing. Examples of the invention include a combination pen and walkie-talkie device in which the walkie-talkie circuitry operates at a transmit/receive frequency within a range of from about 462 MHz to about 467 MHz, including at least one such device which operates at about 462 MHz. Other examples include similar devices in which the transmit/receive antenna is a half-wavelength antenna, e.g., a half-wavelength antenna having a free length greater than one foot, and/or in which the transmit/receive antenna comprises wire wound into a coil having a finished length of less than about 1.5 inches.

### BRIEF DESCRIPTION OF THE DRAWINGS

For a more complete understanding of the present invention, reference is made to the following detailed description of three exemplary embodiments of the present invention, considered in conjunction with the accompanying drawings, in which:

FIG. 1 is a perspective view of a walkie-talkie/pen constructed in accordance with one exemplary embodiment of the present invention;

FIG. 2 is a schematic view of the arrangement of the electronic components of the walkie-talkie/pen shown in FIG. 1;

FIG. 3 is a rear elevational view of the walkie-talkie/pen of FIG. 1;

FIG. 4 is a perspective view of a walkie-talkie/pen constructed in accordance with a second exemplary embodiment of the present invention;

FIG. 5 is a rear elevational view of the walkie-talkie/pen of FIG. 4;

FIG. 6 is a rear elevational view similar to FIG. 5, except that the rear cover of the walkie-talkie/pen has been removed so as to expose certain interior components;

FIG. 7 is a schematic view of the arrangement of the electronic components of the walkie-talkie/pen shown in FIGS. 4-6;

FIG. 8 presents a graph of antenna length vs. frequency; and

FIG. 9 is a perspective view of a walkie-talkie/pen constructed in accordance with a third exemplary embodiment of the present invention.

### DETAILED DESCRIPTION OF THE EXEMPLARY EMBODIMENTS

As will be discussed in greater detail hereinafter, the present invention involves the incorporation of walkie-talkie functionality in a “ball-point pen” writing instrument, wherein all of the walkie-talkie components of the device, including the transmit-receive antenna, fit within the pen's housing. At least in part because of the relatively high frequency used for the transmission and receipt of the walkie-talkie signals, the length of the antenna used in accordance with the present invention is small enough to be entirely enclosed within the pen's housing. As such, the walkie-talkie functionality is well-concealed within a device that looks and functions as a ball-point pen.

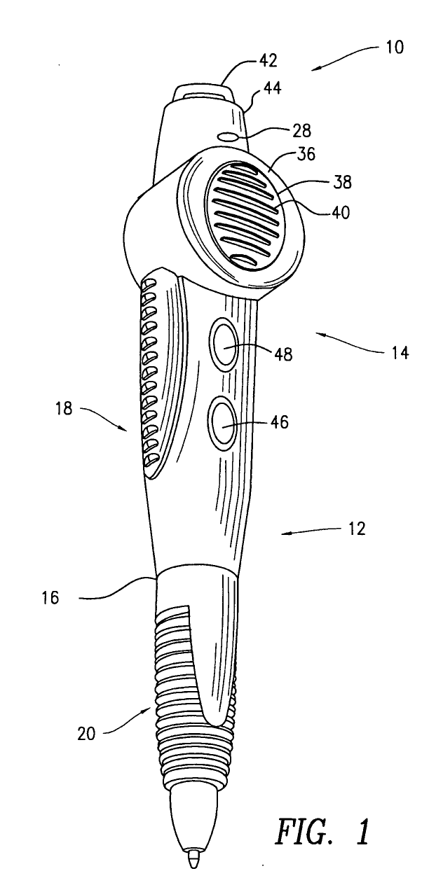

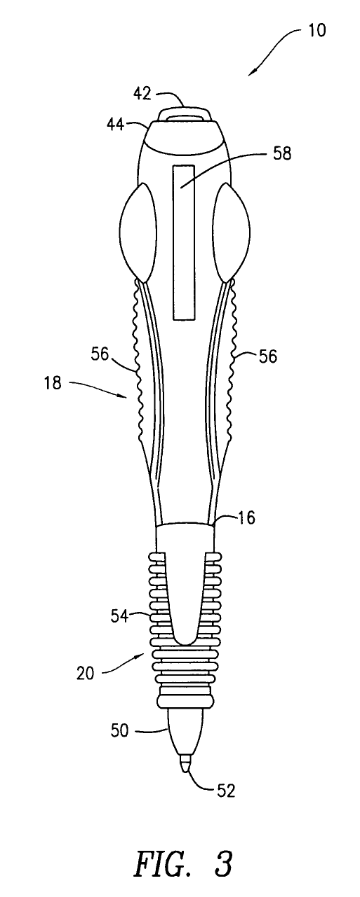

As illustrated in FIGS. 1 and 3, a walkie-talkie/pen 10 according to the present invention includes a pen 12 and a walkie-talkie 14. The pen 12 has a pen housing 16, consisting of an upper barrel 18 and a lower barrel 20. The upper barrel 18 and the lower barrel 20 are joined by means of an internal thread (not shown) to allow the upper barrel 18 and the lower barrel 20 to be separated.

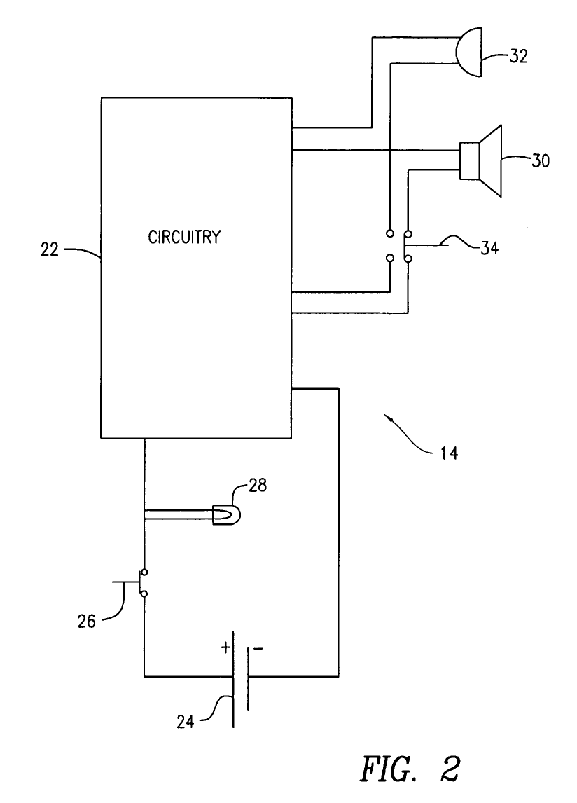

Referring to FIG. 2, the walkie-talkie 14 includes circuitry 22 for transmitting and receiving communications signals in a manner to be described in greater detail hereinafter. The circuitry 22 is contained within the upper barrel 18 of the pen housing 16 along with a battery 24, which serves as the power supply for the walkie-talkie 14. The electrical connection between the circuitry 22 and the battery 24 is established through a single-circuit, push-button switch 26. A test lamp 28 is provided between the switch 26 and the circuitry 22 as a power indicator. The device used as the test lamp 28 should be small in size compared to the width of the upper barrel 18. Preferably, such a device comprises a light-emitting diode (LED). The walkie-talkie 14 is further provided with a speaker 30 and a microphone 32, both of which are connected to the circuitry 22. The speaker 30 and the microphone 32 are activated in alternation by a dual-circuit, push-button switch 34. The speaker 30 and the microphone 32 may be of conventional types known in the art, appropriately sized to fit within the pen housing 16.

Returning to FIG. 1, the upper barrel 18 is provided with a chamber 36 that encloses the speaker 30, which is protected by a cover 38 made of metal or plastic. Openings 40 in the cover 38 allow sound from the speaker 30 to be heard without being significantly muffled by the cover 38. The microphone 32 is located in a microphone housing 42 at a top end 44 of the upper barrel 18 and is situated so as to allow the user the grasp the upper barrel 18 and speak directly into the microphone 32. Two push-button type control buttons 46, 48 are located directly below the chamber 36. The lower control button 46 is a power on/off control button that operates the switch 26 to alternately connect and disconnect the battery 24 (FIG. 2) from the walkie-talkie circuitry 22. The upper control button 48 is a talk function button that operates the switch 34 to alternately activate the microphone 32 and the speaker 30. The test lamp 28 is located in the upper barrel 18 directly above the chamber 36.

As shown in FIG. 3, the lower barrel 20 is provided with a nib housing 50 containing a typical ball-point pen nib 52, which is connected to a ball-point ink supply (not shown) contained within the lower barrel 20. The lower barrel 20 is further provided with a soft rubber feel coating or surface 54 to provide a comfortable grip. Additional soft rubber feel surfaces 56 are attached to the upper barrel 18. The upper barrel 18 is also provided with a typical pen clip 58 opposite the speaker cover 38.

Referring to FIGS. 1-3, to activate the walkie-talkie 14, the user connects the battery 24 to the walkie-talkie circuitry 22 by depressing the power on/off button 46. This causes the test lamp 28 to light. The user then presses the talk function button 48 to activate the microphone 32 and speaks into the microphone housing 42. To listen to a reply, the user releases the talk function button 48, deactivating the microphone 32 and activating the speaker 30. To deactivate the walkie-talkie 14, the user again presses the power on/off control button 46, disconnecting the battery 24 from the walkie-talkie circuitry 22.

It should be appreciated that the walkie-talkie/pen 10 provides numerous advantages. For example, all of the externally visible features of the walkie-talkie 14, including the speaker cover 36, the microphone housing 42, and the switch buttons 46, 48 are of low profile, such that they blend in with the surrounding pen housing 16. At the same time, the pen 12 of the walkie-talkie/pen 10 is fully functional. Also, the lack of an externally visible antenna further conceals the walkie-talkie function. For example, the walkie-talkie/pen 10 can be equipped with a transmit/receive antenna that is entirely enclosed within the pen housing 16, as will be described in more detail hereinafter in connection with additional embodiments of the present invention.

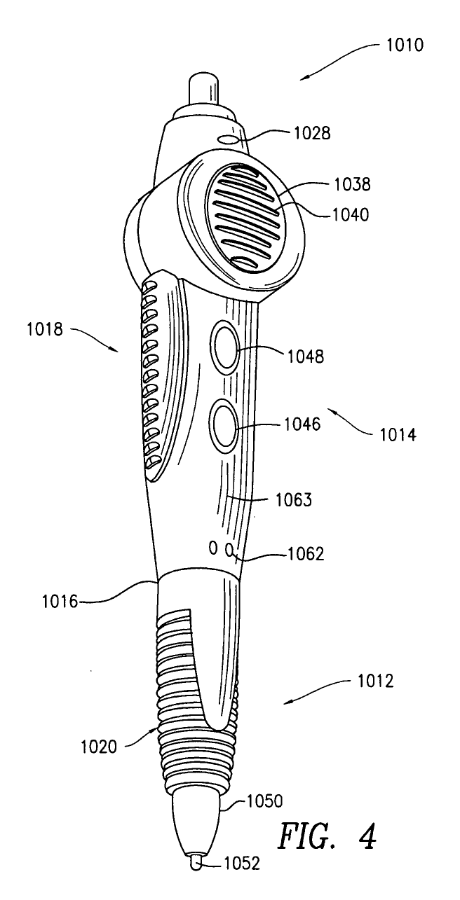

It should also be noted that the walkie-talkie/pen 10 of the present invention can have numerous modifications and variations. For instance, additional exemplary embodiments of the present invention are illustrated in FIGS. 4-9. Elements illustrated in FIGS. 4-9 which correspond substantially to the elements described above with reference to FIGS. 1-3 have been designated by corresponding reference numerals increased by one or more increments of one thousand. The embodiments of the present invention shown in FIGS. 4-9 operate and are constructed in manners consistent with the foregoing description of the walkie-talkie/pen 10, unless it is stated otherwise.

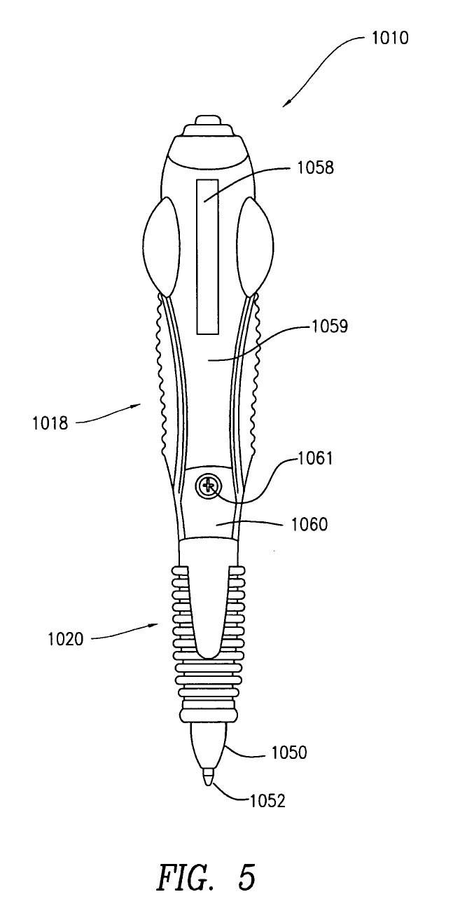

A second embodiment of the present invention is shown in FIGS. 4-7. Referring to FIGS. 4 and 5, the walkie-talkie/pen 1010 includes a pen 1012 having a pen housing 1016 and a walkie-talkie 1014 within the pen housing 1016. To use the pen 1012 of the walkie-talkie/pen 1010, a user rotates the nib housing 1050 located at the bottom of the lower barrel 1020, causing the ball-point pen nib 1052 to extend from within the nib housing 1050 to the fully extended position outside the nib housing 1050 shown in FIGS. 4 and 5. To use the walkie-talkie 1014, the user operates the power on-off control button 1046 for main power activation and deactivation (as indicated by the test lamp 1028), and the talk function button 1048 for alternating between generating and/or transmitting walkie-talkie signals, and receiving and/or monitoring walkie-talkie signals. The upper barrel 1018 is equipped with a rear cover 1059 onto which the pen clip 1058 is secured, and an easily removable battery door 1060 which, for safety, is secured to the rear cover 1059 with a screw 1061.

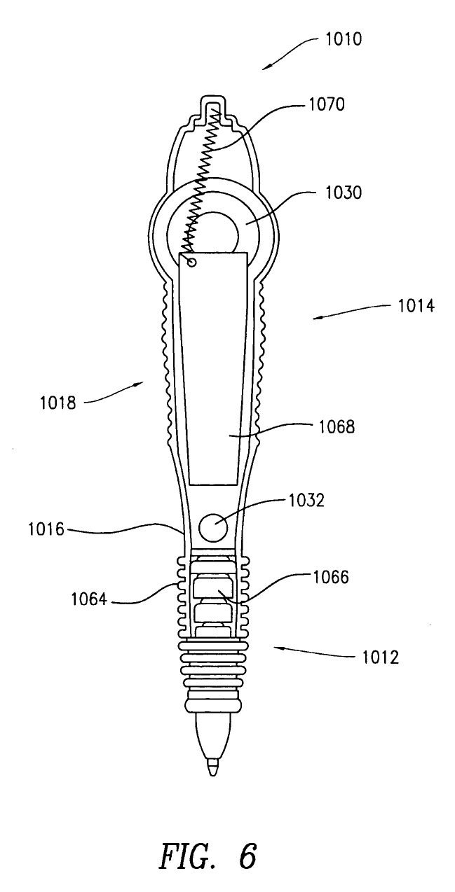

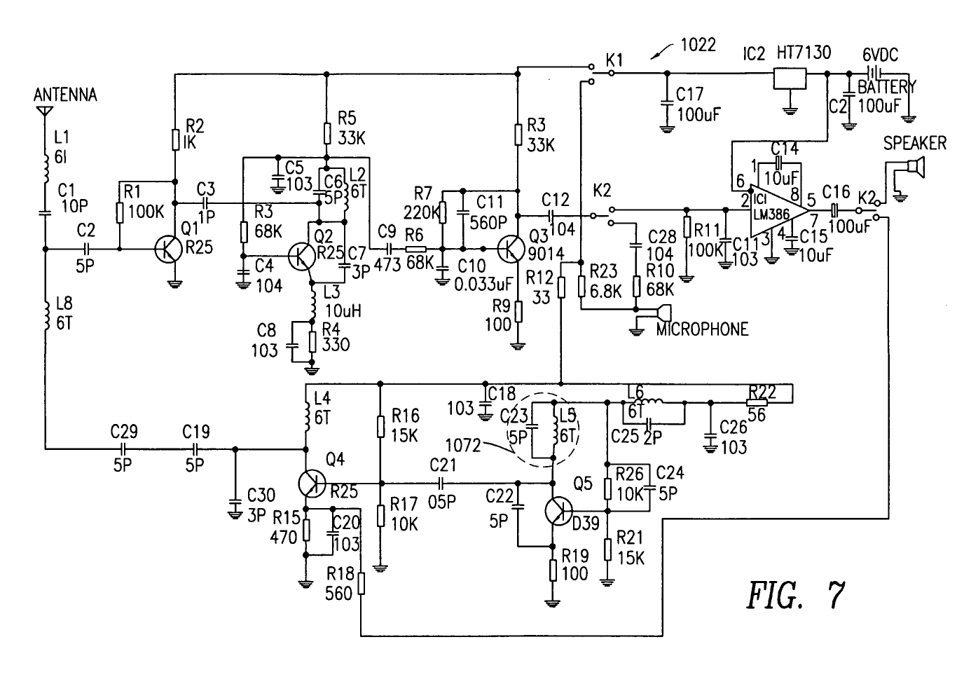

Referring to FIG. 6, internal components of the walkie-talkie/pen 1010 are viewable with the rear cover 1059 (see FIG. 5) of the upper barrel 1018 removed. The microphone 1032 of the walkie-talkie 1014 is located below the speaker 1030 in accordance with the present inventive embodiment. In use, the user holds the walkie-talkie/pen 1010 in hand, speaks into the microphone 1032 through microphone holes 1062 (see FIG. 4) formed in a front side 1063 of the upper barrel 1018, and listens to the return message passing from the speaker 1030 and out of the openings 1040 (see FIG. 4) in the cover 1038. Two such walkie-talkie/pens 1010 separated by a distance of less than one mile may be used by individuals for direct, two-way personal communications, whereby the communications signals transmitted by one of the walkie-talkie/pens 1010 are received directly by the other of the walkie-talkie/pens 1010, and vice-versa. A battery compartment 1064 is provided within the pen housing 1016 containing four button cell batteries 1066, which generate six volts DC for powering a circuit board 1068 of the walkie-talkie 1014, and which are replaceable via the battery door 1060 (see FIG. 5). For the sake of clarity, the components on the circuit board 1068 which make up the walkie-talkie circuitry 1022 (see FIG. 7) are not illustrated.

The walkie-talkie circuitry 1022 operates at an effective radiated power no greater than about 0.5 Watts (e.g., less than or equal to about 0.5 Watts in accordance with FCC regulations regarding “the Family Radio Service” or FRS), transmits at an FRS frequency of about 462 MHz, and receives signals at the same frequency via an internal antenna 1070. The internal antenna 1070 is a half-wavelength wire antenna having a free length of approximately 12-13 inches, and wound into a coil having a finished length of approximately 1.25 inches and a diameter of approximately 0.25 inches. Because of the relatively high frequency at which the walkie-talkie 1014 operates, the antenna 1070 can be of a relatively short finished length not extending past (i.e., beyond, out of, outside of, etc.) the pen housing 1016. As shown in FIG. 7, the walkie-talkie circuitry 1022 includes an R-L-C circuit 1072 for creating the 462 MHz frequency.

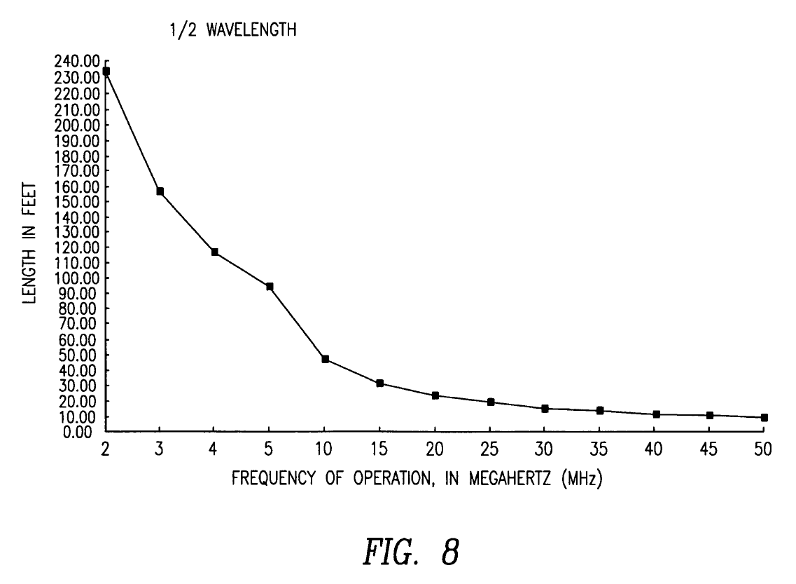

Additional bands within the allocated range of 462-467 MHz are available for use in creating similar devices for facilitating private conversations in accordance with the FCC's Family Radio Service rules. Higher frequencies may be employed as bandwidth allocations are made available by the FCC. A graph of antenna length vs. frequency is provided in FIG. 8, indicating that as the frequency of operation is increased, the required antenna length decreases.

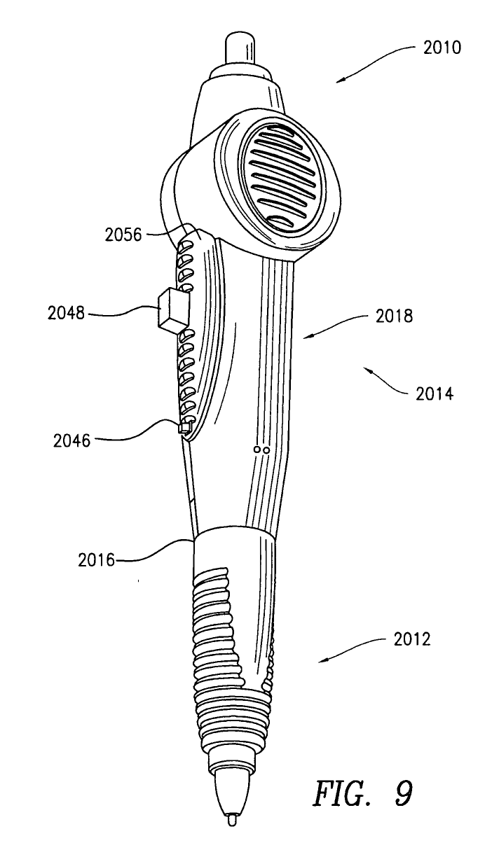

A third embodiment of the present invention is shown in FIG. 9, which illustrates a walkie-talkie/pen 2010 including a pen 2012 having a pen housing 2016 and a walkie-talkie 2014 within the pen housing 2016. The walkie-talkie 2014 has all the functionality of the walkie-talkie 1014 described hereinabove, except that the power on-off control button 2046 and the talk function button 2048 are mounted to one side of an upper barrel 2018 along a rubber feel surface 2056.

It will be understood that the embodiments of the present invention described herein are merely exemplary and that a person skilled in the art may make many variations and modifications without departing from the spirit and scope of the invention. All such variations and modifications, including those discussed above, are therefore intended to be included within the scope of the present invention as set forth in the claims appended hereto.

1. A combination pen and walkie-talkie device, comprising a writing pen including a pen housing having a lower barrel containing a pen nib for writing and an upper barrel above said lower barrel, and a walkie-talkie in said upper barrel of said pen housing, said walkie-talkie including an antenna entirely enclosed within said pen housing, and circuitry coupled to said antenna for alternately transmitting and receiving communications signals using the same frequency.

2. The device of claim 1, wherein said same frequency is a frequency within a range of from about 462 MHz to about 467 MHz.

3. The device of claim 1, wherein said same frequency is a frequency of about 462 MHz.

4. The device of claim 1, wherein said circuitry operates at an effective radiated power less than or equal to about 0.5 Watts.

5. The device of claim 1, wherein said antenna comprises wire wound into a coil having a finished length of less than about 1.5 inches.

6. The device of claim 5, wherein said coil has a finished length of about 1.25 inches or less.

7. The device of claim 1, wherein said antenna is a half-wavelength antenna.

8. The device of claim 7, wherein said half-wavelength antenna has a free length greater than about one foot.

9. The device of claim 1, wherein said walkie-talkie is built into said pen housing in a manner which at least partially conceals the presence of said walkie-talkie.

10. A communications system, comprising first and second walkie-talkies configured for direct communications therebetween on a single transmit/receive frequency, wherein each of said first walkie-talkie and said second walkie-talkie is incorporated within separate pen housings of respective pens, each of said respective pens containing a pen nib for writing, and said first and said second walkie-talkie each including a transmit/receive antenna entirely enclosed within said pen housings of said respective pens.

11. The communications system of claim 10, wherein said single transmit/receive frequency is a frequency of about 462 MHz.

12. The communications system of claim 11, wherein each of said first and said second walkie-talkie includes circuitry for enabling direct communications between said first and said second walkie-talkie on said single transmit/receive frequency, said single transmit/receive frequency being a frequency within a range of from about 462 MHz to about 467 MHz.

13. The communications system of claim 12, wherein said circuitry operates at an effective radiated power less than or equal to about 0.5 Watts.

14. The communications system of claim 10, wherein said transmit/receive antenna comprises wire wound into a coil having a finished length of less than about 1.5 inches.

15. The communications system of claim 14, wherein said coil has a finished length of about 1.25 inches or less.

16. The communications system of claim 10, wherein said transmit/receive antenna is a half-wavelength antenna.

17. The communications system of claim 18, wherein said half-wavelength antenna has a free length greater than about one foot.

18. The communications system of claim 10, wherein said first and said second walkie-talkies are built into said separate pen housings of said respective pens in a manner which at least partially conceals the presence of said first and said second walkie-talkies in said respective pens.
